(19) United States
(12) Patent Application Publication
(10) Pub. No.: US 2012/0281029 A1
(43) Pub. Date: Nov. 8, 2012

(54) METHOD FOR DRIVING PLASMA DISPLAY DEVICE

(76) Inventors: Takahiko Origuchi, Osaka (JP); Hirofumi Honda, Osaka (JP); Hidehiko Shoji, Osaka (JP); Naoyuki Tomioka, Osaka (JP); Kazuhiro Kanai, Osaka (JP)

(21) Appl. No.: 13/520,428

(22) PCT Filed: Jan. 19, 2011
(86) PCT No.: PCT/JP2011/000242

§ 371 Date: Jul. 3, 2012

(30) Foreign Application Priority Data
Jan. 19, 2010 (JP) 2010-008774

(51) Int. Cl. G09G 3/28; G09G 5/00

(52) U.S. Cl. 345/690; 345/60

(57) ABSTRACT

The plasma display apparatus suppresses addressing failure, enhancing stability of address discharge, and therefore, enhancing quality of display image on the panel. The present invention attains above through the followings: preparing display combination sets each of which having difference in number of combinations; determining whether or not magnitude of image signals, except for a predetermined color image signal, is greater than a threshold; and according to the determination above, selecting a set for the predetermined color image signal from the display combination sets. A display combination set used for the predetermined color image signal when the image signals except for the predetermined color image signal have magnitude not less than the threshold is smaller in number of combinations than that used for the predetermined color image signal when the image signals except for the predetermined color image signal have magnitude smaller than the threshold.

### TECHNICAL FIELD

The present invention relates to a driving method of a plasma display apparatus having an AC surface discharge plasma display panel.

### BACKGROUND ART

An AC surface discharge panel, i.e. a typical plasma display panel (hereinafter, simply referred to as a “panel”), has a plurality of discharge cells between a front substrate and a rear substrate oppositely disposed to each other. On a glass substrate of the front substrate, a plurality of display electrode pairs, each including a scan electrode and a sustain electrode, is arranged in parallel with each other. A dielectric layer and a protective layer are formed over the display electrode pairs.

On a glass substrate of the rear substrate, a plurality of data electrodes is arranged in parallel with each other, and over which, a dielectric layer is formed so as to cover them. On the dielectric layer, a plurality of barrier ribs is formed so as to be parallel with the data electrodes. A phosphor layer is formed on the surface of the dielectric layer and on the side surface of the barrier ribs.

The front substrate and the rear substrate are oppositely located in a manner that the display electrode pairs are positioned orthogonal to the data electrodes, and then the two substrates are sealed with each other via discharge space therebetween. The discharge space is filled with, for example, a discharge gas containing xenon at a partial pressure of 5%. Discharge cells are formed at intersections of the display electrode pairs and the data electrodes. In the panel with the structure above, ultraviolet rays are generated by gas discharge in each discharge cell. The ultraviolet rays excite phosphors of the red (R) color, green (G) color, and blue (B) color so that light is emitted for the display of a color image.

A typically used driving method for the panel is a subfield method. In the subfield method, gradations are displayed by dividing one field period into a plurality of subfields and performing light-emission control for each discharge cell in each subfield. Each of the subfields has an initializing period, an address period, and a sustain period.

In the initializing period, a voltage with an initializing waveform is applied to each scan electrode to generate an initializing discharge in each discharge cell. The initializing discharge forms wall charge necessary for the subsequent address operation, and generates priming particles (i.e., excited particles for generating a discharge) for providing an address discharge with stability.

In the address period, scan pulses are sequentially applied to the scan electrodes, at the same time, address pulses are selectively applied to the data electrodes according to an image signal corresponding to display image. The application of voltage generates an address discharge between a scan electrode and a data electrode at a discharge cell to have light emission, and forms wall charge in the discharge cell (hereinafter, the address operation is also referred collectively as “addressing”).

In the sustain period, sustain pulses in number predetermined for each subfield are applied alternately to the scan electrodes and the sustain electrodes of the display electrode pairs. The application of the pulses generates a sustain discharge in the discharge cells having undergone the address discharge and causes the phosphor layers to emit light in the discharge cells, by which each discharge cell emits light at a luminance corresponding to a luminance weight determined for each subfield. (Hereinafter, light emission of a discharge cell caused by a sustain discharge may be represented by “light-on” and no light emission of a discharge cell may be represented by “light-off”). Thus, each discharge cell of the panel emits light at a luminance corresponding to the gradation values of image signals, displaying an image in the image display area of the panel.

A plasma display apparatus driven by a subfield method for displaying image on the panel often has an unwanted phenomenon—an electric charge moves between adjacent discharge cells. Hereinafter, the phenomenon is referred to crosstalk. The crosstalk can cause decrease in electric charge in a discharge cell and invite an unstable addressing, resulting in degradation of quality of display image. In the description below, the phenomenon where a normal address discharge is not obtained due to an unstable addressing will be referred to addressing failure.

To address the problem above, a suggestion for decreasing crosstalk has been made (for example, see patent literature 1). According to the method, the gradation for image display is determined by selecting a light emitting pattern wherein the on/off states of continuous subfields in continuous gradations are prevented from being switched.

The method of patent literature 1 is effective in decreasing a crosstalk when it occurs between adjacent discharge cells in a column direction (that is, the discharge cells are disposed adjacent in a direction in which a data electrode extends and the discharge cells share the same data electrode). However, the method has difficulty in decreasing a crosstalk that occurs between adjacent discharge cells in a row direction (that is, the discharge cells are disposed adjacent in a direction in which a display electrode pair extends and the discharge cells share the same display electrode pair).

Besides, the recent trend moving toward increasingly high-definition of the panel further shortens the interval between the discharge cells disposed adjacent in the row direction, accordingly, a crosstalk easily occurs between the discharge cells. Therefore, in a plasma display apparatus having a high-definition panel, manufacturers are seeking a method capable of minimizing an adverse effect caused by the crosstalk on display image.

### CITATION LIST

### Patent Literature

### PTL1

Japanese Patent Unexamined Publication No. 2004-29265

### SUMMARY OF THE INVENTION

According to the driving method of a plasma display apparatus of the present invention, one field is formed of a plurality of subfields each of which having a predetermined luminance weight. At the same time, display combination sets are prepared by selecting a plurality of combinations to be used for gradation display from a plurality of combinations differing in combination of a light emission subfield and a non light emission subfield. Of such prepared display combination sets, one set is selected according to an image signal. With the selected display combination set, emission control of the discharge cells is carried out for each subfield, so that the panel offers gradation display. Further, a plurality of display combination sets, each of which has difference in number of combinations, is prepared, and which set is used depends on whether or not the magnitude of image signals—except for an image signal representing a predetermined color—is greater than a predetermined threshold. According to the result above, the display combination set used for the image signal of a predetermined color is selected from the plurality of display combination sets. The display combination set used for a predetermined color image signal when the image signals except for the predetermined color image signal have magnitude not less than a predetermined threshold is smaller in number of combinations than the display combination set used for a predetermined color image signal when the image signals except for the predetermined color image signal have magnitude smaller than a predetermined threshold.

With the method above, prior to the light emission of the discharge cells, a light emitting combination that can generate crosstalk is changed to a light emitting combination that suppresses the crosstalk. The decrease in crosstalk suppresses addressing failure, enhancing stability in address discharge; accordingly, enhancing quality of display image on the panel.

In the driving method of a plasma display apparatus of the present invention, each of the display combination sets has the following rule—a discharge cell having no light emission in a specified subfield also has no light emission in subfields following the specified subfield. The number of the specified subfields in the display combination set having the smaller number of combinations may be greater than that in the display combination set having the larger number of combinations.

Besides, in the driving method above, a predetermined color image signal may be a blue color image signal.

Further, in the driving method above, a specified subfield in the display combination set having the smaller number of combinations may include the first subfield, the second subfield, and the third subfield of one field.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 is a chart of driving voltage waveforms applied to respective electrodes of the panel used for the plasma display apparatus in accordance with the exemplary embodiment.

FIG. 4 is a coding table used for the plasma display apparatus in accordance with the exemplary embodiment.

FIG. 5 is a circuit block diagram of the plasma display apparatus in accordance with the exemplary embodiment.

FIG. 6 is a circuit block diagram showing the image signal processing circuit of the plasma display apparatus in accordance with the exemplary embodiment.

FIG. 7 is a diagram showing the lowest value of address pulse voltage necessary for generating an address discharge in each of the discharge cells of emitting red, green, and blue in each subfield.

FIG. 8A is a diagram showing a combination of gradation that can fail in generating a sustain discharge caused by an unstable address operation due to crosstalk.

FIG. 8B is a diagram showing another combination of gradation that can fail in generating a sustain discharge caused by an unstable address operation due to crosstalk.

### DESCRIPTION OF EMBODIMENTS

Hereinafter, a plasma display apparatus in accordance with an exemplary embodiment of the present invention is described, with reference to the accompanying drawings.

### EXEMPLARY EMBODIMENT

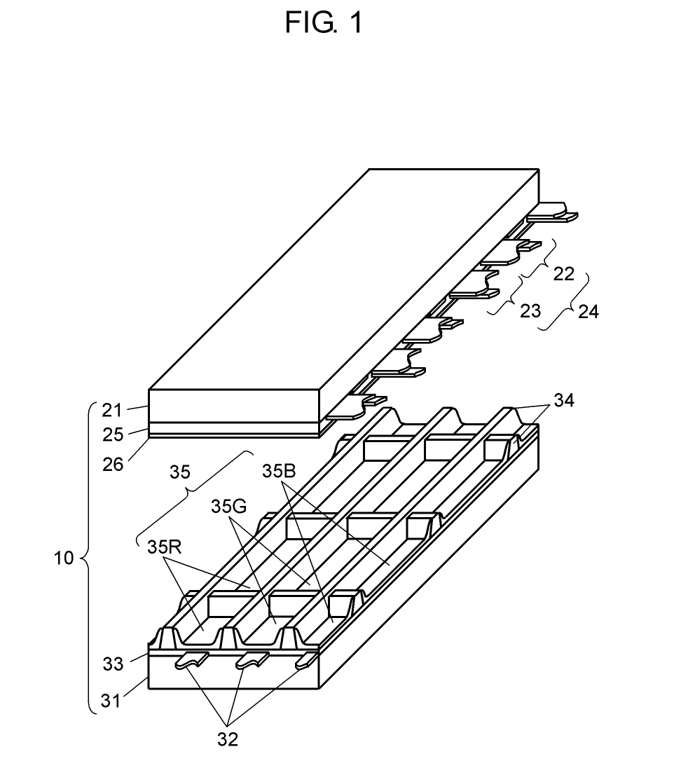

FIG. 1 is an exploded perspective view showing a structure of panel 10 for use in a plasma display apparatus in accordance with an exemplary embodiment of the present invention. A plurality of display electrode pairs, each including scan electrode 22 and sustain electrode 23, is formed on front substrate 21 made of glass. Dielectric layer 25 is formed so as to cover scan electrodes 22 and sustain electrodes 23. Protective layer 26 is formed over dielectric layer 25.

Protective layer 26 is made of a material predominantly composed of magnesium oxide (MgO). The material is proven as being effective in decreasing a discharge start voltage in the discharge cells. Besides, the MgO-based material offers a large coefficient of secondary electron emission and high durability against discharge gas having neon (Ne) and xenon (Xe).

A plurality of data electrodes 32 is formed on rear substrate 31. Dielectric layer 33 is formed so as to cover data electrodes 32, and grid-like barrier ribs 34 are formed on the dielectric layer. On the side faces of barrier ribs 34 and on dielectric layer 33, phosphor layer 35R for emitting light of red (R) color, phosphor layer 35G for emitting light of green (G) color, and phosphor layer 35B for emitting light of blue (B) color are formed. Hereinafter, phosphor layers 35R, 35G, 35B are referred to collectively as phosphor layer 35.

Front substrate 21 and rear substrate 31 face each other such that display electrode pairs 24 intersect data electrodes 32 with a small discharge space formed between the electrodes. The outer peripheries of the substrates are sealed with a sealing material, such as a glass frit. The inside of the discharge space is filled with discharge gas, for example, a mixture gas of neon and xenon. In the embodiment, the discharge gas contains xenon with partial pressure of approx. 15% for enhancing emission efficiency in the discharge cells.

Barrier ribs 34 divide the discharge space into a plurality of compartments. Discharge cells are formed in the intersecting parts of display electrode pairs 24 and data electrodes 32. In panel 10, one pixel is formed by three successive discharge cells arranged in the extending direction of display electrode pairs 24. The three discharge cells are a red-color discharge cell having phosphor layer 35R for emitting light of red (H) color, a green-color discharge cell having phosphor layer 35G for emitting light of green (G) color, and a blue-color discharge cell for emitting light of blue (B) color. Hereinafter, a red-color discharge cell that emits red light is referred to as an R discharge cell, a green-color discharge cell that emits green light is referred to as a G discharge cell, and a blue-color discharge cell that emits blue light is referred to as a B discharge cell. The discharge cells have a discharge and emit light (light on) so as to display a color image on panel 10.

The structure of panel 10 is not limited to the above, and may include barrier ribs formed into a stripe pattern, for example. The mixture ratio of the discharge gas is not limited to the aforementioned numerical value, and other mixture ratios may be used. For example, the xenon partial pressure may be increased for enhancing emission efficiency.

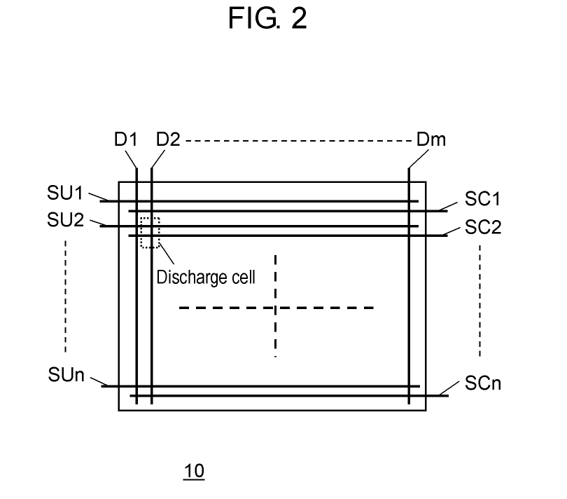

FIG. 2 is an electrode array diagram of panel 10 for use in the plasma display apparatus in accordance with the exemplary embodiment of the present invention. Panel 10 has n scan electrodes SC1 through SCn (that form scan electrodes 22 in FIG. 1) and n sustain electrodes SU1 through SUn (that form sustain electrodes 23 in FIG. 1) both long in the row (line) direction, and m data electrodes D1 through Dm (that form data electrodes 32 in FIG. 1) long in the column direction. A discharge cell is formed in the part where a pair of scan electrode SCi (i=1 to n) and sustain electrode SUi intersects one data electrode Dj (j=1 to m). That is, m discharge cells (i.e. m/3 pixels) are formed for each display electrode pair 24. In the discharge space, m×n discharge cells are formed. The area having m×n discharge cells is the image display area of panel 10. For example, in a panel having 1920×1080 pixels, m=1920×3 and n=1080. Although n=1080 in the embodiment, it is not to be construed as limiting value.

Next, the method for driving panel 10 of the plasma display apparatus of the exemplary embodiment will be described. The plasma display apparatus of the embodiment display gradations by a subfield method. In the subfield method, one field is divided into a plurality of subfields along a temporal axis, and a luminance weight is set for each subfield. Each of the subfields has an initializing period, an address period, and a sustain period. By controlling the light emission and no light emission for each discharge cell in each subfield, an image is displayed on panel 10.

The luminance weight represents a ratio of the magnitudes of luminance displayed in the respective subfields. In the sustain period of each subfield, sustain pulses corresponding in number to the luminance weight are generated. For example, the light emission in the subfield having the luminance weight “8” is approximately eight times as high as that in the subfield having the luminance weight “1”, and approximately four times as high as that in the subfield having the luminance weight “2”. Therefore, the selective light emission caused by the combination of the respective subfields in response to image signals allows the panel to display various gradations forming an image.

In this exemplary embodiment, one field is divided into six subfields (subfield SF1, subfield SF2, . . . , subfield SF6). Respective subfields have luminance weights of 1, 2, 4, 8, 16, and 32.

In the initializing period of one subfield out of the subfields, an initializing discharge is generated unexceptionally in all the discharge cells—the all-cell initializing operation. In each initializing period of other subfields, an initializing discharge is generated selectively in the discharge cells having undergone an address discharge in the address period of the immediately preceding subfield—the selective initializing operation. Hereinafter, a subfield having the all-cell initializing operation is referred to as an all-cell initializing subfield, while a subfield having the selective initializing operation is referred to as a selective initializing subfield.

In the embodiment, the description will be given on a case where subfield SF1 is the all-cell initializing subfield, and subfields SF2 through SF6 are the selective initializing subfields. With the structure above, the light emission with no contribution to image display is only the light emission caused by the discharge in the all-cell initializing operation in subfield SF1. That is, the display area of luminance of black where luminance of black is displayed due to no sustain discharge has only weak light emission caused by the all-cell initializing operation. Thereby, an image of high contrast can be displayed on panel 10.

In the sustain period of each subfield, sustain pulses based on the luminance weight of the corresponding subfield multiplied by a predetermined proportionality factor are applied to each of display electrode pairs 24. This proportionality factor is a luminance magnification.

In each sustain period, sustain pulses are applied to each of scan electrodes 22 and sustain electrodes 23. At this time, the number of sustain pulses to be applied to each electrode is calculated by multiplying the luminance weight of each subfield and a predetermined luminance magnification. Therefore, when the luminance magnification is 2, in the sustain period of a subfield having a luminance weight of 2, each of scan electrode 22 and sustain electrode 23 undergoes four-time application of sustain pulses. That is, the number of sustain pulses generated in the sustain period of the subfield is 8.

However, in this exemplary embodiment, the number of subfields forming one field, or the luminance weights of the respective subfields is not limited to the above values. For example, one field may be divided into ten subfields (subfield SF1, subfield SF2, . . . , subfield SF10), and each of the subfields may have the following luminance weights: 1, 2, 3, 6, 11, 18, 30, 44, 60, and 81. Further, the subfield structure may be switched in response to an image signal, for example.

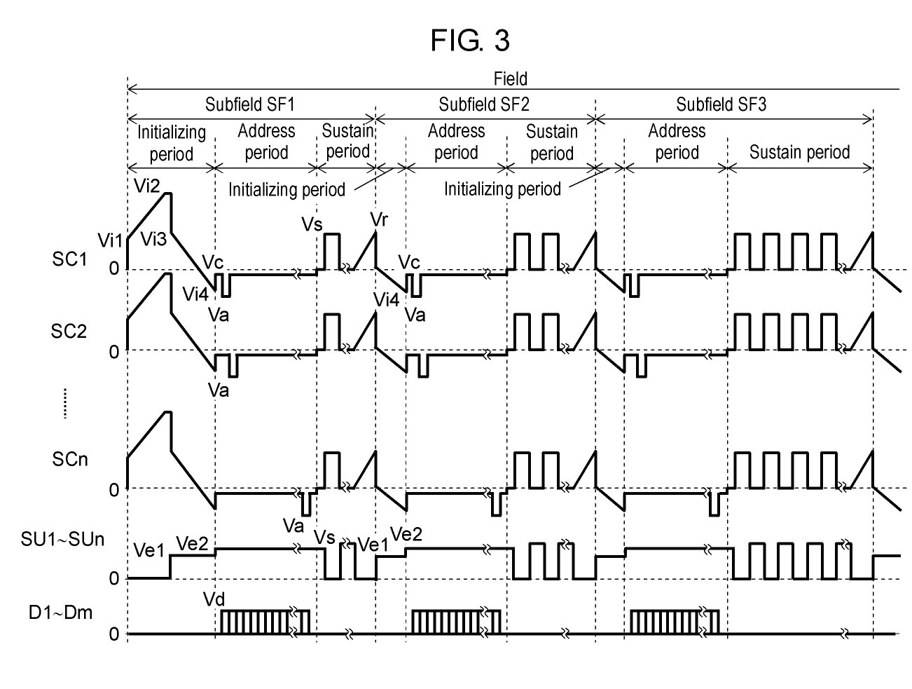

FIG. 3 is a chart of driving voltage waveforms applied to the respective electrodes of panel 10 for use in the plasma display apparatus in accordance with the exemplary embodiment of the present invention. FIG. 3 shows driving voltage waveforms applied to scan electrode SC1 that undergoes address operation first in the first row in an address period, scan electrode SC2 that undergoes address operation next to scan electrode SC1 in the address period, scan electrode SCn that undergoes address operation last in the address period, sustain electrodes SU1 through SUn, and data electrodes D1 through Dm.

FIG. 3 shows two types of subfields having difference in waveform of driving voltage applied to scan electrodes SC1 through SCn in an initializing period. The first type corresponds to subfield SF1 as an all-cell initializing subfield, and the second type corresponds to subfields SF2 and SF3 as a selective initializing subfield. The driving voltage waveforms used for other subfields is similar to that of subfield SF2 except for the number of sustain pulses. Scan electrode SCi, sustain electrode SUi, and data electrode Dk in the description below are the electrodes selected from the respective electrodes, based on image data (i.e., data representing the light emission and no light emission in each subfield).

First, a description is provided for subfield SF1 as the all-cell initializing subfield.

In the first half of the initializing period of subfield SF1, 0 (V) is applied to data electrodes D1 through Dm, and sustain electrodes SU1 through SUn. Voltage Vi1 is applied to scan electrodes SC1 through SCn. Voltage Vi1 is set to a voltage lower than a discharge start voltage with respect to sustain electrodes SU1 through SUn. Further, a ramp voltage gently rising from voltage Vi1 toward voltage V12 is applied to scan electrodes SC1 through SCn. Voltage Vi2 is set to a voltage exceeding the discharge start voltage with respect to sustain electrodes SU1 through SUn. For example, the voltage gradient of the ramp voltage may be set to approx. 1.3V/μsec.

While the ramp voltage is rising, a weak initializing discharge continuously occurs between scan electrodes SC1 through SCn and sustain electrodes SU1 through SUn, and between scan electrodes SC1 through SCn and data electrodes D1 through Dm. Through the discharge, negative wall voltage accumulates on scan electrodes SC1 through SCn, and positive wall voltage accumulates on data electrodes D1 through Dm and sustain electrodes SU1 through SUn. This wall voltage on the electrodes means voltages that are generated by the wall charge accumulated on the dielectric layers covering the electrodes, the protective layer, the phosphor layers, or the like.

In the second half of the initializing period, positive voltage Ve1 is applied to sustain electrodes SU1 through SUn, and 0 (V) is applied to data electrodes D1 through Dm. A ramp voltage gently falling from voltage V13 to negative voltage V14 is applied to scan electrodes SC1 through SCn. Voltage Vi3 is set to a voltage lower than the discharge start voltage with respect to sustain electrodes SU1 through SUn, and voltage V14 is set to a voltage exceeding the discharge start voltage. For example, the voltage gradient of the ramp voltage may be set to approx. −2.5V/μsec.

While the ramp voltage is applied to scan electrodes SC1 through SCn, a weak initializing discharge occurs between scan electrodes SC1 through SCn and sustain electrodes SU1 through SUn, and between scan electrodes SC1 through SCn and data electrodes D1 through Dm. This weak discharge reduces the negative wall voltage on scan electrodes SC1 through SCn and the positive wall voltage on sustain electrodes SU1 through SUn, and adjusts the positive wall voltage on data electrodes D1 through Dm to a value appropriate for the address operation. In this manner, the all-cell initializing operation for causing an initializing discharge in all the discharge cells is completed.

In the subsequent address period, scan pulses of voltage Va are sequentially applied to scan electrodes SC1 through SCn. At the same time, an address pulse of positive voltage Vd is applied to data electrode Dk of a discharge cell to be lit in data electrodes D1 through Dm. The application of voltage selectively generates an address discharge in each discharge cell.

To be specific, first, voltage Vet is applied to sustain electrodes SU1 through SUn, voltage Vc is applied to scan electrodes SC1 through SCn, and voltage 0 (V) is applied to data electrodes D1 through Dm.

Next, a scan pulse of negative voltage Va is applied to scan electrode SC1 that undergoes the address operation first in the first row. At the same time, an address pulse of positive voltage Vd is applied to data electrode Dk of a discharge cell to be lit in the first row in data electrodes D1 through Dm. Through the application of the pulses, the voltage difference in the intersecting part of data electrode Dk and scan electrode SC1 is calculated by adding the difference between the wall voltage on data electrode Dk and the wall voltage on scan electrode SC1 to the externally applied voltage difference (=voltage Vd−voltage Va). In this way, the voltage difference between data electrode Dk and scan electrode SC1 exceeds the discharge start voltage, generating a discharge between the two electrodes above.

As described above, voltage Ve2 is applied to sustain electrodes SU1 through SUn. Through the application of the voltage, the voltage difference between sustain electrode SU1 and scan electrode SC1 is calculated by adding the difference between the wall voltage on sustain electrode SU1 and the wall voltage on scan electrode SC1 to the externally applied voltage difference (=voltage Ve2−voltage Va). At this time, by setting voltage Ve2 at a voltage value just below the discharge start voltage, a “discharge-prone” state just before an actual discharge generation is given between sustain electrode SU1 and scan electrode SC1.

The discharge occurred between data electrode Dk and scan electrode SC1 triggers a discharge between sustain electrode SU1 and scan electrode SC1 that are disposed in the area intersecting to data electrode Dk. Thus, an address discharge occurs in the discharge cell to be lit. Positive wall voltage accumulates on scan electrode SC1, and negative wall voltage accumulates on sustain electrode SU1 and on data electrode Dk.

In this manner, address operation is performed to cause an address discharge in the discharge cells to be lit in the first row and to accumulate wall voltage on the respective electrodes. On the other hand, because of no application of address pulses, the voltage of the intersecting part of scan electrode SC1 and data electrodes 32 does not exceed the discharge start voltage; accordingly, no address discharge occurs.

Next, a scan pulse is applied to scan electrode SC2 in the second row. At the same time, an address pulse is applied to data electrode Dk of a discharge cell to be lit in the second row. In a discharge cell to which a scan pulse and an address pulse are simultaneously applied, an address discharge is generated, i.e., the address operation is performed.

In a similar way, the address operation is sequentially performed and, on the completion of the address operation on the discharge cells in the n-th row, the address period is over. In the address period, as described above, an address discharge is selectively generated in a discharge cell to be lit, and wall charge is formed in the discharge cell.

In the subsequent sustain period, voltage 0 (V) is applied to sustain electrodes SU1 through SUn, and at the same time, sustain pulses of positive voltage Vs are applied to scan electrodes SC1 through SCn. In the discharge cells having undergone the address discharge, the voltage difference between scan electrode SCi and sustain electrode SUi is calculated by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0 (V) is applied to scan electrodes SC1 through SCn, and sustain pulses of voltage Vs are applied to sustain electrodes SU1 through SUn. In the discharge cells having undergone the sustain discharge, the voltage difference between sustain electrode SUi and scan electrode SCi exceeds the discharge start voltage. Thereby, a sustain discharge occurs again between sustain electrode SUi and scan electrode SCi. Negative wall voltage accumulates on sustain electrode SUi, and positive wall voltage accumulates on scan electrode SCi.

Similarly, sustain pulses are alternately applied to scan electrodes SC1 through SCn and sustain electrodes SU1 through SUn. The number of sustain pulses applied to the electrodes above corresponds to a number calculated by multiplying the luminance weight and a predetermined luminance magnification. Through the application of the pulses, a sustain discharge is continuously generated in the discharge cells having undergone the address discharge in the address period.

After the sustain pulses have been generated in the sustain period (i.e., at the end of the sustain period), a ramp waveform voltage gently rising from 0 (V) as the base electric potential toward voltage Vr is applied to scan electrodes SC1 through SCn while 0 (V) is applied to sustain electrodes SU1 through SUn and data electrodes D1 through Dm. The voltage gradient of the ramp waveform voltage at that time is, for example, approx. 10V/μsec. Voltage Vr is determined to be higher than the discharge start voltage, by which a weak discharge continuously occurs between sustain electrode SUi and scan electrode SCi at a discharge cell having undergone a sustain discharge, while the voltage applied to scan electrodes SC1 through SCn is increasing over the discharge start voltage.

Charged particles generated by this weak discharge accumulate as wall charge on sustain electrode SUi and scan electrode SCi so as to reduce the voltage difference between sustain electrode SUi and scan electrode SCi. Thereby, in the discharge cells having undergone the sustain discharge, the wall voltage on scan electrode SCi and sustain electrode SUi is partially or entirely erased, while the positive wall voltage is maintained on data electrode Dk.

After the rising voltage applied to scan electrodes SC1 through SCn has reached voltage Vr, the voltage is lowered to voltage 0 (V) as a base potential. Thus, the sustain operation in the sustain period is completed.

The driving voltage waveform used in the initializing period of subfield SF2 differs from that used in subfield SF1 in that the first half of the waveform is omitted. That is, voltage Ve1 is applied to sustain electrodes SU1 through SUn, and 0 (V) is applied to data electrodes D1 through Dm. A ramp waveform voltage is applied to scan electrodes SC1 through SCn. The ramp voltage gently falls from a voltage lower than the discharge start voltage (e.g. voltage 0 (V)) toward negative voltage V14 exceeding the discharge start voltage. The voltage gradient of the ramp voltage is, for example, approx. −2.5V/μsec.

With the application of voltage, a weak initializing discharge occurs in the discharge cells having undergone a sustain discharge in the sustain period of the immediately preceding subfield (i.e. subfield SF1 in FIG. 3). This weak discharge reduces the wall voltage on scan electrode SCi and sustain electrode SUi. The wall voltage on data electrode Dk is adjusted to a value suitable for the address operation. In contrast, in the discharge cells having undergone no sustain discharge in the sustain period of the immediately preceding subfield, no initializing discharge occurs, and the wall charge at the completion of the initializing period of the immediately preceding subfield is maintained.

In this manner, in the initializing period of subfield SF2, a selective initializing operation is performed so as to selectively cause an initializing discharge in the discharge cells having undergone a sustain discharge in the sustain period of the immediately preceding subfield. Hereinafter, the period having a selective initializing operation is referred to as a selective initializing period.

The driving voltage waveforms applied to each electrode in the address period and the sustain period of subfield SF2 are nearly the same as those used in the address period and the sustain period of subfield SF1, except for the number of the sustain pulses. Further, the driving voltage waveforms applied to each electrode in other subfields after subfield SF3 are nearly the same as those used in subfield SF2, except for the number of the sustain pulses.

The description above has provided an overview of the driving voltage waveforms applied to the electrodes of panel 10 of the embodiment.

Preferably, each value of voltage to be applied to the electrodes is set optimally for the characteristics of the panel, the specifications of the plasma display apparatus, or the like.

Next, a method for obtaining light emission of discharge cells with luminance weight suitable for a gradation level will be described. In the description below, the wording of “emitting a discharge cell with luminance weight suitable for a gradation level” may be expressed by the wording of “displaying gradation”. Besides, combination of a subfield with light emission and a subfield with no light emission is referred to as “coding”.

In the embodiment, as described above, one field is formed of a plurality of subfields each of which having a predetermined luminance weight. Out of a plurality of different combinations (coding) of subfields with light emission and subfields with no light emission, two-or-more sets for display for displaying gradation (display coding) are selected to make “display combination sets”. To display gradation on panel 10, a single pattern of display coding is selected from the display combination sets according to image signals, and light emission/no light emission of discharge cells is controlled for each subfield with reference to the selected display coding. Hereinafter, the display combination set is referred to as a “coding table”.

Next, the coding table used in the embodiment will be described. Hereinafter, for the sake of simplicity, the gradation for displaying black is represented as gradation 0 and the gradation corresponding to luminance weight N is represented as gradation N. For example, the gradation of a discharge cell in which only subfield SF1 with luminance weight 1 emits light is represented as gradation 1. The gradation of a discharge cell in which subfield SF1 with luminance weight 1 and subfield SF2 with luminance weight 2 emit light is represented as gradation 3.

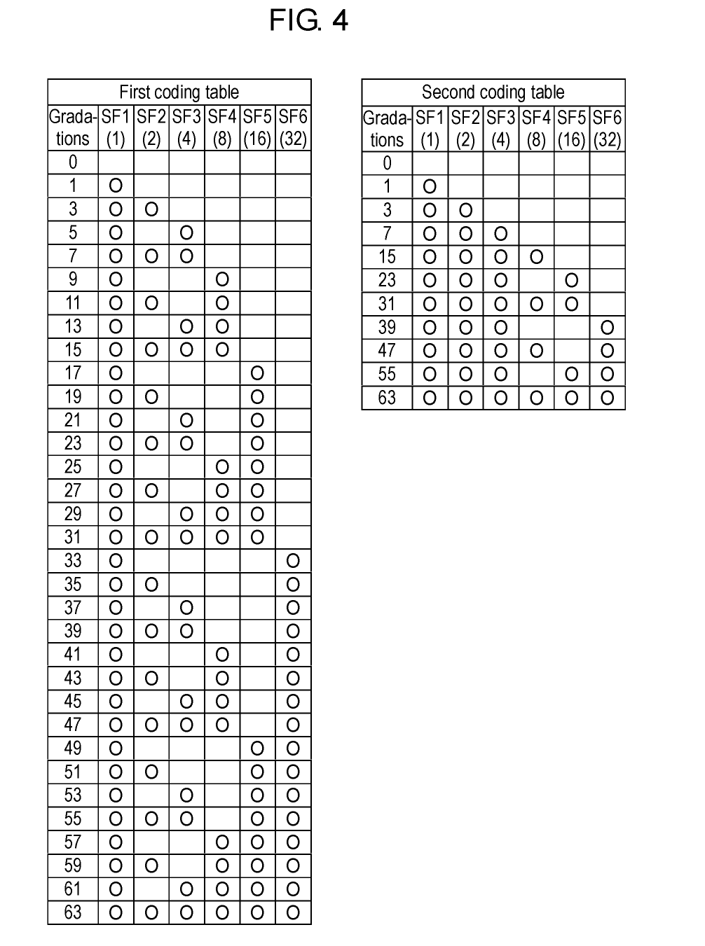

According to the embodiment, the plasma display apparatus has a plurality of coding tables (for example, two coding tables) having difference in the number of display coding patterns. FIG. 4 is a coding table used for the plasma display apparatus in accordance with the exemplary embodiment. FIG. 4 shows two coding tables (i.e. the first coding table and the second coding table) used for the plasma display apparatus in accordance with the exemplary embodiment. The first coding table differs from the second coding table in the number of display coding patterns.

In the coding tables shown in FIG. 4, one field is formed of six subfields SF1 through SF6, and the subfields have the following luminance weights: 1, 2, 4, 8, 16, and 32.

In the coding tables in FIG. 4, a gradation level for each discharge cell is shown as a numerical value in the leftmost column, and each line with the respective value shows combination of light emission and no light emission of the subfields to obtain the gradation level. In the coding tables above, a blank column represents that the corresponding subfield has no light emission, and a “o”-marked column represents that the corresponding subfield has light emission.

For example, when a discharge cell displays gradation 3 with the use of the first coding table, the discharge cell has light emission in subfield SF1 with luminance weight 1 and in subfield SF2 with luminance weight 2. When a discharge cell displays gradation 23, the discharge cell has light emission in subfield SF1 with luminance weight 1, in subfield SF2 with luminance weight 2, in subfield SF3 with luminance weight 4, and in subfield SF5 with luminance weight 16.

The first coding table of FIG. 4 has 33 levels of gradation, and therefore, the first coding table has 33 display coding patterns. The first coding table has the rule that subfield SF1 always has light emission when a discharge cell displays gradation 1 or greater. In other words, a discharge cell that has no light emission in subfield SF1 has also no light emission in subfield SF2 or later.

The second coding table of FIG. 4 has 11 levels of gradation, and therefore, the second coding table has 11 display coding patterns. The second coding table has the following rule: subfield SF1 always has light emission in a discharge cell that displays gradation 1 or greater; subfields SF1 and SF2 always have light emission in a discharge cell that displays gradation 3 or greater; and subfields SF1, SF2, and SF3 always have light emission in a discharge cell that displays gradation 7 or greater. In other words, a discharge cell that has no light emission in subfield SF1 has no light emission in subfield SF2 or later; a discharge cell that has no light emission in subfield SF2 has no light emission in subfield SF3 or later; and a discharge cell that has no light emission in subfield SF3 has no light emission in subfield SF4 or later.

That is, both of the coding tables of FIG. 4 have a common rule—a discharge cell that has no light emission in a specified subfield has no light emission in the subfields that follow the specified subfield.

As shown in FIG. 4, the first coding table has 33 patterns of display coding (i.e. 33 levels of gradation), and the specified subfield corresponds to subfield SF1.

The second coding table has 11 patterns of display coding (i.e. 11 levels of gradation), and the specified subfield corresponds to subfields SF1, SF2, and SF3.

In the embodiment, as described above, the specified subfield is not limited to one in number. The first coding table, which has greater number of the display coding patterns than the second coding table, has a single specified subfield, whereas the second coding table has three specified subfields.

Hereinafter, a coding table is simply referred to as a table, and accordingly, the first coding table and the second coding table are referred to as the first table and the second table, respectively.

In the first table of FIG. 4, there are no coding patterns for even-numbered level of gradation. That is, even-numbered gradations, such as gradation 2, gradation 4, and gradation 6, cannot be displayed by using the first table. On the other hand, the second table of FIG. 4 does not have the coding patterns for displaying gradations 2, 4, 5, 6, 8, 9, 10, and so on. Such levels of gradations cannot be displayed by using the second table. However, as for the levels that are not included in the tables, a similar level of gradation is attained by using dithering or error diffusion as a generally known method.

The plasma display apparatus of the embodiment uses the first and the second tables shown in FIG. 4, while switching between them according to an image signal.

The structure of the plasma display apparatus of an exemplary embodiment of the present invention will be described below.

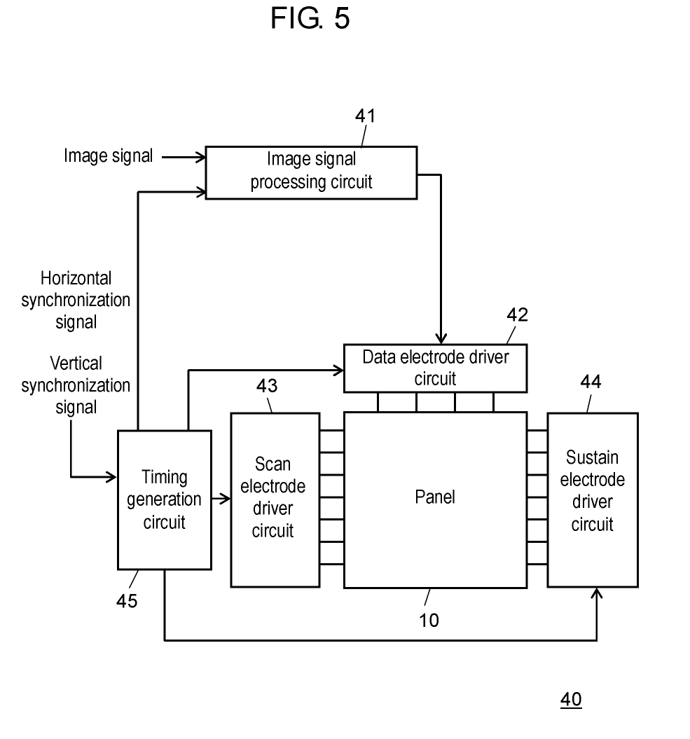

FIG. 5 is a circuit block diagram of plasma display apparatus 40 in accordance with the exemplary embodiment. Plasma display apparatus 40 has panel 10 and a driver circuit. The driver circuit includes image signal processing circuit 41, data electrode driver circuit 42, scan electrode driver circuit 43, sustain electrode driver circuit 44, timing generation circuit 45, and an electric power supply circuit (not shown) for supplying electric power necessary for each circuit block.

Image signal processing circuit 41 allocates gradation values (gradation values represented in one field) to each discharge cell, based on an input image signal. The image signal processing circuit converts the gradation values into image data representing light emission and no light emission (where, light emission and no light emission correspond to ‘1’ and ‘0’, respectively, of digital signals) in each subfield with reference to the first table or the second table. For example, suppose that one field is divided into six subfields of SF1 through SF6 and respective subfields have the following luminance weight: 1, 2, 4, 8, 16, and 32. In response to an image signal, when determining a gradation value of 3 to a discharge cell with reference to the first table, image signal processing circuit 41 outputs ‘110000’ as image data for the discharge cell. Similarly, when determining a gradation value of 23 to a discharge cell, image signal processing circuit 41 outputs ‘111010’ as image data for the discharge cell.

When an input image signal includes a red image signal (R signal), a green image signal (0 signal), and a blue image signal (B signal), image signal processing circuit 41 allocates R, G, and B gradation values to the respective discharge cells, based on the R signal, G signal, and B signal. When the input image signal includes a luminance signal (Y signal) and a chroma signal (C signal, R-Y signal and B-Y signal, u signal and v signal, or the like), image signal processing circuit 41 calculates the R signal, the G signal, and the B signal according to the luminance signal and the chroma signal, and allocates the R, G, and B gradation values to the respective discharge cells. After that, image signal processing circuit 41 converts the R, G, and B gradation values allocated to the respective discharge cells into image data (of red image data, green image data, and blue image data) representing light emission and no light emission in each subfield.

Timing generation circuit 45 generates timing signals for controlling the operation of each circuit block, based on a horizontal synchronization signal and a vertical synchronization signal, and supplies the generated timing signals to respective circuit blocks (e.g. image signal processing circuit 41, data electrode driver circuit 42, scan electrode driver circuit 43, and sustain electrode driver circuit 44).

Scan electrode driver circuit 43 has an initializing waveform generation circuit, a sustain pulse generation circuit, and a scan pulse generation circuit (not shown in FIG. 5). Scan electrode driver circuit 43 generates driving voltage waveforms based on the timing signals fed from timing generation circuit 45, and applies the voltage waveforms to scan electrodes SC1 through SCn. The initializing waveform generation circuit generates an initializing waveform to be applied to scan electrodes SC1 through SCn in the initializing periods. Based on the timing signals, the sustain pulse generation circuit generates a sustain pulse to be applied to scan electrodes SC1 through SCn in the sustain periods. The scan pulse generation circuit has a plurality of scan electrode driver ICs (scan ICs), and generates a scan pulse to be applied to scan electrodes SC1 through SCn in the address periods.

Sustain electrode driver circuit 44 has a sustain pulse generation circuit, and a circuit for generating voltage Ve1 and voltage Ve2 (not shown in FIG. 5). In response to the timing signals supplied from timing generation circuit 45, sustain electrode driver circuit 44 generates driving voltage waveforms and applies them to sustain electrodes SU1 through SUn. In a sustain period, sustain electrode driver circuit 44 generates sustain pulses in response to the timing signals and applies the sustain pulses to sustain electrodes SU1 through SUn.

Receiving the image data of each color fed from image signal processing circuit 41, data electrode driver circuit 42 converts the data into address pulses to be applied to data electrodes 32. Based on the timing signals fed from timing generation circuit 45, data electrode driver circuit 42 applies the address pulses to data electrodes D1 through Dm in an address period.

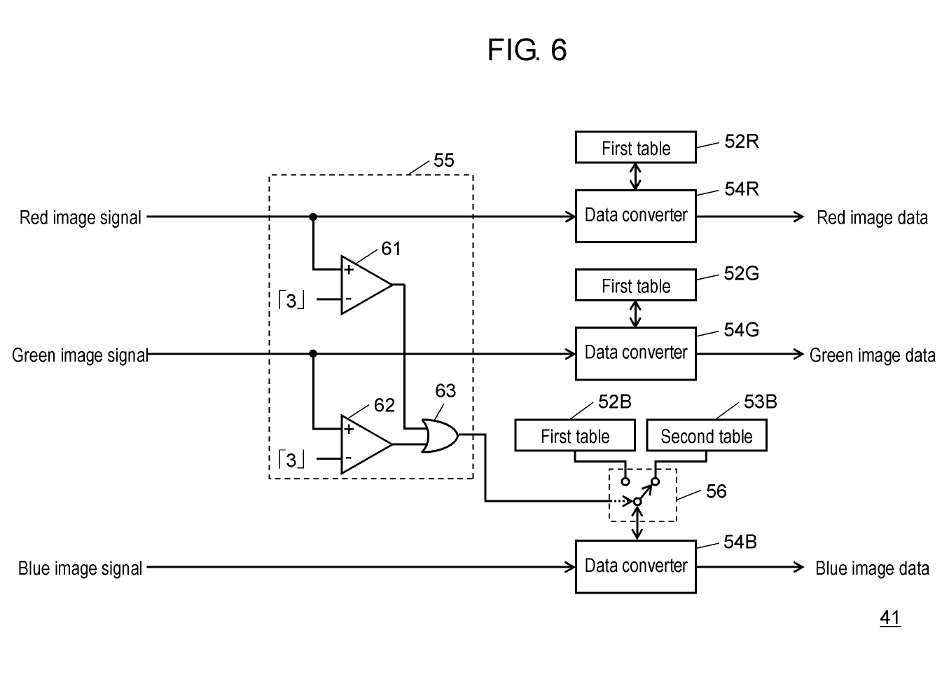

FIG. 6 is a circuit block diagram showing image signal processing circuit 41 of plasma display apparatus 40 in accordance with an exemplary embodiment.

Image signal processing circuit 41 has first table 52R for R (red image) signals, first table 52G for G (green image) signals, first table 52B for B (blue image) signals, second table 53B for B signals, data converter 54R for R signals, data converter 54G for G signals, data converter 54B for B signals, table determining section 55, and selector 56.

The R, G, B signals represent gradations to be shown on panel 10, and they have undergone image processing necessary for image display on panel 10, such as gamma compensation and pixel count conversion. Each signal (of R, G, and B) forming one pixel is processed in each of data converters 54 and fed therefrom at a synchronized timing.

Each of first tables 52R, 52G, 52B, and second table 53B is a memory storage device, such as semiconductor memory, capable of storing data and retrieving a desired one out of the data. The first table of FIG. 4 is stored in each of first tables 52R, 52G, 52B, whereas the second table of FIG. 4 is stored in second table 53B.

Receiving an R signal, data converter 54R retrieves one item of data from first table 52R and outputs it as red image data.

Receiving a G signal, data converter 54G retrieves one item of data from first table 52G and outputs it as green image data.

Receiving a B signal, data converter 54B retrieves one item of data from first table 52B and outputs it as blue image data.

Table determining section 55 has comparators 61, 62 and OR gate 63.

Comparator 61 makes a comparison between an R signal and a predetermined threshold. If the R signal has magnitude equivalent to the threshold or greater, comparator 61 outputs a signal of ‘H’ level; otherwise, outputs a signal of ‘L’ level. In the embodiment, the threshold is determined to be 3. That is, comparator 61 outputs a signal of ‘H’ level for an R signal with gradation level equivalent to 3 or greater; otherwise, outputs a signal of ‘L’ level.

Comparator 62 makes a comparison between a G signal and a predetermined threshold. If the G signal has magnitude equivalent to the threshold or greater, comparator 62 outputs a signal of ‘H’ level; otherwise, outputs a signal of ‘L’ level. In comparator 62, too, the threshold is determined to be 3. That is, comparator 62 outputs a signal of ‘H’ level for a G signal with gradation level equivalent to 3 or greater than 3; otherwise, outputs a signal of ‘L’ level.

OR gate 63 offers logical addition of outputs of comparator 61 and comparator 62. If both of comparator 61 and comparator 62 have outputs of ‘L’ level, OR gate 63 outputs a signal of ‘L’ level; otherwise, outputs a signal of ‘H’ level.

That is, the output of table determining section 55 depends on the following condition. If at least any one of the R signal and the G signal has magnitude of gradation 3 or greater, table determining section 55 outputs a signal of ‘H’ level. If both of the R signal and the G signal have magnitude smaller than gradation 3, table determining section 55 outputs a signal of ‘L’ level.

Selector 56 is a selection circuit having two selectable input/output terminals and one input/output terminal. According to the output signal from OR gate 63, selector 56 electrically connects any one of the two selectable input/output terminals to one input/output terminal. One of the two selectable input/output terminals is connected to first table 52B, and the other is connected to second table 53B. One input/output terminal is connected to data converter 54B. When receiving an output signal of ‘H’ level from OR gate 63, selector 56 electrically connects between second table 53B and data converter 54B. When receiving an output signal of ‘L’ level from OR gate 63, selector 56 electrically connects between first table 52B and data converter 54B.

That is, if at least any one of the R signal and the G signal has magnitude of gradation 3 or greater, data converter 54B retrieves data from second table 53B according to a received B signal. If both of the R signal and the G signal have magnitude smaller than gradation 3, data converter 54B retrieves data from first table 52B according to the received B signal. And, data converter 54B outputs the retrieved data from any one of the tables above as the blue image data.

According to the driving method of plasma display apparatus of the embodiment, as described above, on comparison between the magnitude of the image signals—except for an image signal of a predetermined color—and a predetermined threshold, the display combination set (table) used for the image signal of a predetermined color is selected from the plurality of display combination sets. The display combination set used for a predetermined color image signal when the image signals except for the predetermined color image signal have magnitude not less than a predetermined threshold is smaller in number of combinations than the display combination set used for a predetermined color image signal when the image signals except for the predetermined color image signal have magnitude smaller than a predetermined threshold.

To be specific, if at least any one of the R signal and the G signal has magnitude equivalent to a predetermined threshold (for example, of 3) or greater, the second table is selected; otherwise, the first table is selected as the table used for data conversion from the B signal to blue image data. At that time, the number of the display coding patterns of the second table is smaller than that of the first table.

The second table has three specified subfields—subfield SF1, subfield SF2, and subfield SF3, whereas the first table has one specified subfield—subfield SF1 only. That is, the second table, which has smaller in number display coding patterns than the first table, has greater number of specified subfields than the first table.

Next, the structural advantage of image signal processing circuit 41 of the embodiment will be described.

As described earlier, crosstalk is a phenomenon in which electric charge moves between adjacent discharge cells. The occurrence of crosstalk is quantitatively determined by using the lowest value of voltage of address pulses (hereinafter, address pulse voltage) necessary for generating a stable address discharge. When crosstalk occurs, wall charges in a discharge cell decrease. The decrease in wall charge in the discharge cell increases the lowest value of address pulse voltage necessary for generating an address discharge in the successive subfield.

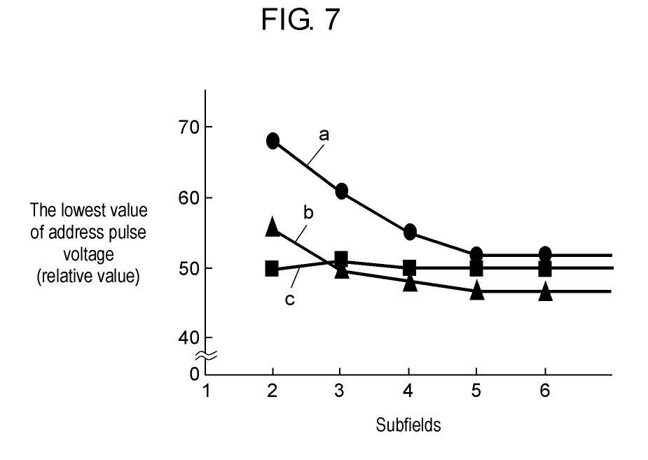

FIG. 7 is a diagram showing the lowest value of address pulse voltage necessary for generating an address discharge in each of the discharge cells of emitting red, green, and blue in a subfield. The horizontal axis of the graph represents the subfields and the vertical axis represents the lowest value of address pulse voltage for generating an address discharge in each subfield.

The result of FIG. 7 is obtained by an experiment having the procedures below. Of three discharge cells forming one pixel in a subfield, one discharge cell to be the target of measurement (i.e., the targeted discharge cell) is kept in turn-off, while other two discharge cells are turned on. After that, the lowest value of address pulse voltage necessary for generating an address discharge in the targeted discharge cell is measured in the immediately after subfield.

In FIG. 7, graphs (a), (b), and (c) show each result when the B discharge cell, the R discharge cell, and the G discharge cell, respectively, are determined to be the targeted discharge cell.

For example, graph (a) shows that the address pulse voltage in subfield SF2 has a lowest value of approx. 68 V. The result is obtained by the measurement on the following conditions: in subfield SF1, the B discharge cell is kept in turn-off, while the R discharge cell and the G discharge cell are turned on; after that, measurement on address pulse voltage in subfield SF2 is carried out. That is, the lowest value of the address pulse voltage necessary for generating an address discharge in the B discharge cell measures approx. 68 V.

The measurement results of FIG. 7 were obtained by an experiment on the following subfield structure: one field is divided into six subfields from subfield SF1 through subfield SF6, and respective subfield has luminance weights of 1, 2, 4, 8, 16, and 32.

According to the first table and the second table of the embodiment, all the gradation levels but gradation 0 have light emission in subfield SF1. That is, subfield SF1 is not likely to have crosstalk. The description below therefore focuses on the crosstalk occurred in subfield SF2 or later, omitting the measurement result in subfield SF2 shown in FIG. 7.

As is apparent from graph (a) in FIG. 7, in subfields SF3 and SF4, the lowest value of address pulse voltage in the B discharge cell is higher than the values in the R discharge cell and in the G discharge cell. In the B discharge cell, the lowest value of the address pulse voltage in subfield SF3 measures approx. 61 V, and the lowest value in subfield SF4 measures approx. 55 V. In contrast, graph (c) shows that the lowest value of the address pulse voltage in subfield SF3 of the G discharge cell measures approx. 51 V. The difference in lowest value is brought by the fact—the B discharge cell has serious crosstalk in subfields SF2 and SF3, by which wall charge decreases; and accordingly wall voltage decreases.

In plasma display apparatus 40 having panel 10, the occurrence of crosstalk in the case below can invite addressing failure. That is, of the discharge cells of red, green, and blue that form one pixel, when the B discharge cell is kept in turn-off while the R discharge cell and the G discharge cell are turned on in subfield SF2 or subfield SF3, crosstalk occurs in the B discharge cell and wall charge in the B discharge cell decreases. As a result, the B discharge cell has unstable address operation in the immediately after subfield, which can cause addressing failure, resulting in no generation of a sustain discharge.

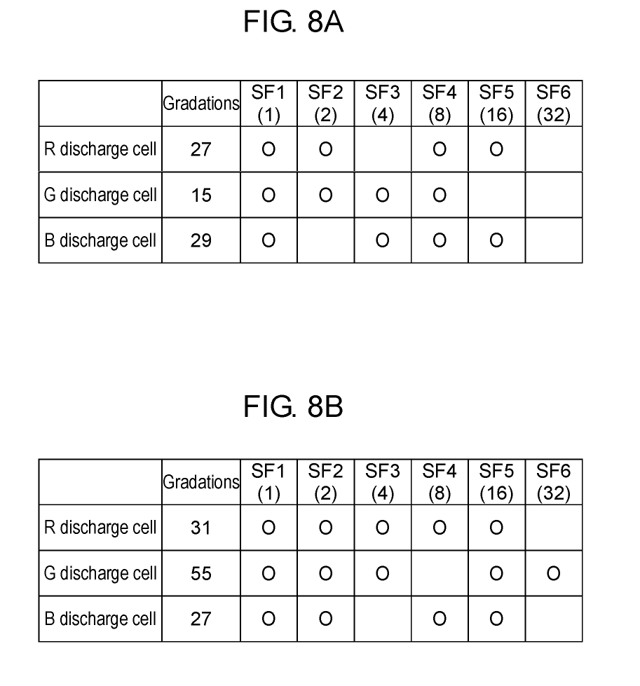

FIG. 8A is a diagram showing a combination of gradation that can fail in generating a sustain discharge caused by an unstable address operation due to crosstalk FIG. 8B is a diagram showing another combination of gradation that can fail in generating a sustain discharge caused by an unstable address operation due to crosstalk. In the examples of FIGS. 8A and 8B, a blank column represents that the corresponding subfield has no light emission, and a “o”-marked column represents that the corresponding subfield has light emission.

As shown in FIGS. 8A and 8B, one field has six subfields (of subfield SF1 through subfield SF6), and the luminance weight of each subfield is as follows: 1, 2, 4, 8, 16, and 32.

According to the combination of gradation of FIG. 8A, the R discharge cell displays gradation 27, the G discharge cell displays gradation 15, and the B discharge cell displays gradation 29. When each gradation level is converted into image data with reference to the first table of FIG. 4, the R discharge cell has image data of ‘110110’, the G discharge cell has image data of ‘111100’, and the B discharge cell has image data of ‘101110’ (where, ‘1’ represents light emission and ‘0’ represents no light emission). As a result, in subfield SF2, the R discharge cell and the G discharge cell have light emission, whereas the B discharge cell has no light emission.

In the case above, discharge generation in the R discharge cell and in the G discharge cell can cause crosstalk in the B discharge cell, by which wall voltage of the B discharge cell tends to decrease. The decrease in wall voltage can invite an unstable address discharge in the B discharge cell in the address period of subfield SF3, resulting in no generation of a sustain discharge. The addressing failure above can cause no initializing discharge in the successive subfield, resulting in addressing failure and no generation of a sustain discharge again in the subfield. If the current subfield has an unstable address discharge and has no generation of a sustain discharge, the addressing failure can repeatedly occur in the rest of the subfields. In the worst case, the gradation level may decrease to gradation 1 in the B discharge cell where gradation 29 should be attained.

Similarly, in the combination of gradation of FIG. 8B, the R discharge cell displays gradation 31, the G discharge cell displays gradation 55, and the B discharge cell displays gradation 27. When each gradation level is converted into image data with reference to the first table of FIG. 4, the R discharge cell has image data of ‘111110’, the G discharge cell has image data of ‘111011’, and the B discharge cell has image data of ‘110110’ (where, ‘1’ represents light emission and ‘0’ represents no light emission). As a result, in subfield SF3, the R discharge cell and the G discharge cell have light emission, whereas the B discharge cell has no light emission.

In the case above, discharge generation in the R discharge cell and in the G discharge cell can cause crosstalk in the B discharge cell, by which wall voltage of the B discharge cell tends to decrease. The decrease in wall voltage can invite an unstable address discharge in the B discharge cell in the address period of subfield SF4, resulting in no generation of a sustain discharge. The addressing failure above can cause no initializing discharge in the successive subfield, resulting in addressing failure and no generation of a sustain discharge again in the subfield. If the current subfield has an unstable address discharge and has no generation of a sustain discharge, the addressing failure can repeatedly occur in the rest of the subfields. In the worst case, the gradation level may decrease to gradation 3 in the B discharge cell where gradation 27 should be attained.

In the two examples above, however, if the B discharge cell has light emission in subfield SF2 (in the example of FIG. 8A) and in subfield SF3 (in the example of FIG. 8B), the problem above can be avoided.

The experiment result shown in FIG. 7 apparently shows that a B discharge cell easily undergoes crosstalk. As described above, a combination of light emission—in which the B discharge cell has no light emission, whereas the R discharge cell and the G discharge cell have light emission—can cause crosstalk in the B discharge cell. Further, another combination—in which the B discharge cell has no light emission and the R discharge cell or the G discharge cell has light emission—can cause crosstalk in the B discharge cell. In the combination above, too, if the B discharge cell has light emission, there is no need to find the presence or absence of crosstalk with respect to the B discharge cell. Eliminating the section for detecting whether the B discharge cell has light emission or not from the circuit contributes to the simplicity of the circuit structure.

According to the structure of the embodiment, based on whether at least any one of the R discharge cell and the G discharge cell has light emission, either the first table or the second table is selected and employed for the coding table for converting a blue image signal into blue image data.

As described earlier, crosstalk does not likely occur in subfield SF1 in the embodiment. That is, crosstalk does not likely occur when both the R signal and the G signal have magnitude smaller than gradation 3. Conversely, crosstalk can occur when at least any one of the R signal and the G signal has magnitude equivalent to gradation 3 or greater.

The structure of the embodiment suppresses the occurrence of crosstalk in the B discharge cell as follows. That is, if table determining section 55 detects that at least any one of the R signal and the G signal has magnitude equivalent to gradation 3 or greater, image signal processing circuit 41 employs second table 53B so as to suppress the occurrence of crosstalk in the B discharge cell. According to the received B signal, image signal processing circuit 41 reads data from second table 53B to obtain blue image data.

Employing the table above offers light-emission control of the subfields with respect to the B discharge cell according to the gradation level of the B signal: subfield SF1 always has light emission for gradation 1 or greater; subfields SF1 and SF2 always have light emission for gradation 3 or greater; and subfields SF1, SF2, and SF3 always have light emission for gradation 7 or greater.

As described above, crosstalk easily occurs in a specified combination of light emission—the B discharge cell has no light emission while at least any one of the R discharge cell and the G discharge cell has light emission in a subfield, and after that, the B discharge cell has light emission in a successive subfield. The structure of the embodiment finds the unwanted combination and changes it so that the B discharge cell has light emission in the subfield. The light-emission control above suppresses occurrence of crosstalk in the B discharge cell in the subfield, preventing the rest of the subfields from addressing failure in the B discharge cells. As a result, an address discharge is generated in stable condition.

As described earlier, crosstalk does not likely occur when table determining section 55 detects that both the R signal and the G signal have magnitude smaller than gradation 3. In that case, for better gradation display, image signal processing circuit 41 selects first table 52B having the coding patterns greater in number than those of the second table 53B. Image signal processing circuit 41 thus reads data from first table 52B as blue image data according to a received B signal.

As shown by graph (a) in the measurement result of FIG. 7, the lowest value of address pulse voltage in the B discharge cell measures approx. 52 V at both subfield SF4 and subfield SF5, which differs only slightly from those in the R discharge cell and in the G discharge cell. That is, the graph shows that, as for subfields SF4 and SF5, the occurrence of crosstalk in the B discharge cell is not noticeable.

Therefore, the second table has no rule that subfield SF4 and subfield SF5 always have light emission. Further, if crosstalk occurs in subfield SF6, the successive subfield is subfield SF1 having all-cell initializing operation. That is, the address operation in subfield SF1 will be less affected by the crosstalk in previous subfield SF6.

Besides, as for the levels that are not included in the first and the second tables, a similar level of gradation is attained by using dithering or error diffusion as a generally known method.

Even if the aforementioned light-emission combination—the B discharge cell has no light emission while at least any one of the R discharge cell and the G discharge cell has light emission—occurs, as long as the B discharge cell has no light emission in the successive sub fields, the occurrence of crosstalk has no effect on gradation display.

According to the structure of the embodiment, as described above, the image signal processing circuit has a plurality of coding tables (i.e. the first table and the second table) each of which having difference in number of coding patterns. At the same time, the image signal processing circuit detects a combination of light emission that can cause crosstalk. When detecting such a combination, the image signal processing circuit uses the second table, as for a discharge cell of a specified color that easily causes crosstalk (e.g. the B discharge cell in the embodiment), and converts the image signal into image data. Otherwise, the image signal processing circuit uses the first table having coding patterns greater in number than those of the second table for data conversion.

Both the first and the second tables are formed on the rule that a discharge cell having no light emission in a specified subfield has also no light emission after the subfields that follow the specified subfield. Besides, the second table has two-or-more specified subfields.

With the method above, prior to the light emission of the discharge cells, a combination of light emission that has possible to occur crosstalk is changed to a combination that suppresses the crosstalk. The decrease in crosstalk suppresses addressing failure, enhancing stability in address discharge; accordingly, enhancing quality of display image on the panel.

The description of the embodiment has been given on the crosstalk that can generate in the following case: out of the discharge cells of three colors forming one pixel, a target discharge cell has no light emission, while other two discharge cells have light emission in a specified subfield. However, the target discharge cell may not be disposed in the middle of the three discharge cells of one pixel. That is, the target discharge cell and the two discharge cells adjacently disposed on the both sides of the target cell may not form one pixel. In that case, according to the arrangement of three discharge cells forming one pixel, a one-pixel delay circuit may be disposed between input of the OR gate and output of comparator 61 or output of comparator 62. The structure above is effective in suppressing crosstalk caused by light emission of the two discharge cells adjacently disposed on the both sides of the target discharge cell.

According to the structure described in the embodiment, the B signal is determined to be the specified color image signal, and therefore, the image signal processing circuit switches the coding table between the first table and the second table for converting the blue image signal into blue image data. This is because an experiment has shown a high incidence of crosstalk in the B discharge cells of panel 10 employed in the embodiment. However, in some panels, crosstalk may easily occur in the R or G discharge cells, not in the B discharge cells. That is, the color should be targeted may depend on characteristics of a panel. In that case, too, the structure above is similarly employed except for changing the targeted color from blue to specified color.

Although image signal processing circuit 41 has the first table and the second table and switches between the two tables, according to an image signal in the embodiment, it is not limited to. For example, the image signal processing circuit may switch the coding tables greater than two, according to an image signal.

Suppose that the image signal processing circuit has three coding tables (of the first table, the second table, and the third table). In that case, for example, the coding table used for conversion of the B signal into image data may be as follows:
if both the R signal and the G signal have gradation level smaller than gradation 3, the first table is selected;
if the R signal or the G signal has gradation level of gradation 3 or greater, the second table is selected; and
if both the R signal and the G signal have gradation level of gradation 3 or greater, the third table is selected.

In the structure above, the first table may be formed on the rule that a discharge cell having no light emission in subfield SF1 has also no light emission in subfield SF2 or later. The second table may be formed on the rule that a discharge cell having no light emission in subfield SF1 has also no light emission in subfield SF2 or later, and a discharge cell having no light emission in subfield SF2 has also no light emission in subfield SF3 or later. The third table may be formed on the rule that a discharge cell having no light emission in subfield SF1 has also no light emission in subfield SF2 or later, a discharge cell having no light emission in subfield SF2 has also no light emission in subfield SF3 or later, and a discharge cell having no light emission in subfield SF3 has also no light emission in subfield SF4 or later.

Similarly, when the image signal processing circuit has three coding tables (of the first table, the second table, and the third table), the following selection is also effective in conversion of the B signal:
if the R signal or the G signal has gradation level smaller gradation 3, the first table is selected;
if the R signal or the G signal has gradation level of gradation 3 or greater and smaller than gradation 7, the second table is selected; and
if the R signal or the G signal has gradation level of gradation 7 or greater, the third table is selected.

As described earlier, the second table shown in FIG. 4 has the following rule—a discharge cell that has no light emission in subfield SF1 has no light emission in subfield SF2 or later; a discharge cell that has no light emission in subfield SF2 has no light emission in subfield SF3 or later; and a discharge cell that has no light emission in subfield SF3 has no light emission in subfield SF4 or later. This is grounded on the experimental result, as shown in FIG. 7, that the B discharge cell often undergoes crosstalk in subfield SF2 or subfield SF3. The rule of the second table should preferably be determined to be suitable for characteristics of a panel.

Each circuit block shown in the exemplary embodiments of the present invention may be formed as an electric circuit that performs each operation shown in the exemplary embodiment, or formed of a microcomputer programmed so as to perform the similar operation, for example.

Each control signal described in the embodiments does not necessarily have the polarity described in the embodiments; a control signal having opposite polarity can be employed, as long as it works similar to that in the structure described in the embodiments.

In the example described in the exemplary embodiments, one pixel is formed of discharge cells of three colors of R, G, and B. Also a panel that includes discharge cells that form a pixel of four or more colors can use the configuration shown in this exemplary embodiment and provide the same advantage.

The aforementioned driver circuit is only shown as an example in the exemplary embodiments of the present invention. The present invention is not limited to the structure of the driver circuit.

The specific numerical values shown in the exemplary embodiments of the present invention are set based on the characteristics of panel 10 that has a 50-inch screen and 1080 display electrode pairs 24, and simply show examples in the exemplary embodiment. The present invention is not limited to these numerical values. Preferably, each numerical value is set optimally for the characteristics of the panel, the specifications of the plasma display apparatus, or the like. Variations are allowed for each numerical value within the range in which the above advantages can be obtained. Further, the number of subfields, the luminance weights of the respective subfields, or the like is not limited to the values shown in the exemplary embodiments of the present invention. The subfield structure may be switched according to image signals, for example.

### INDUSTRIAL APPLICABILITY

The present invention allows a plasma display apparatus—even having a high-definition large-sized panel—to suppress addressing failure, enhancing stability of address discharge; and accordingly, enhancing quality of display image on the panel. Thus, the present invention is useful in providing a method for driving a plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35 phosphor layer
40 plasma display apparatus
41 image signal processing circuit
42 data electrode driver circuit
43 scan electrode driver circuit
44 sustain electrode driver circuit
45 timing generation circuit
52R, 52G, 52B first table
53B second table
54R, 54G, 54B data converter
55 table determining section
56 selector
61, 62 comparator
63 OR gate

1. A method of driving a plasma display apparatus displaying gradations on a plasma display panel,
wherein, one field is formed by a plurality of subfields each of which having a predetermined luminance weight, and display combination sets are prepared by selecting a plurality of combinations to be used for gradation display from a plurality of combinations differing in combination of a light emission subfield and a non light emission subfield, and one combination is selected from the display combination sets according to an image signal so as to be used for controlling light emission and non light emission of discharge cells on a subfield basis,
the method comprising:
preparing a plurality of display combination sets each of which differs in number of the combinations;
determining whether or not a magnitude of image signals except for a predetermined color image signal is greater than a predetermined threshold; and
selecting a display combination set used for the predetermined color image signal from the plurality of display combination sets according to the determining result,
wherein a display combination set used for the predetermined color image signal when the image signals except for the predetermined color image signal have magnitude not less than the predetermined threshold is smaller in number of combinations than a display combination set used for the predetermined color image signal when the image signals except for the predetermined color image signal have magnitude smaller than the predetermined threshold.

2. The method of driving a plasma display apparatus of claim 1, wherein each of the plurality of display combination sets has a rule that a discharge cell having no light emission in a specified subfield also has no light emission in subfields following the specified subfield, and the number of the specified subfields in the display combination set having the smaller number of combinations is greater than the number of the specified subfields in the display combination set having the larger number of combinations.

3. The method of driving plasma display apparatus of claim 1 or claim 2, wherein the specified color image signal is a blue image signal.

4. The method of driving plasma display apparatus of claim 2, wherein the specified subfield in the display combination set having the smaller number of combinations includes the first subfield, the second subfield, and the third subfield disposed in one field.
